(19) United States
(12) Patent Application Publication
(10) Pub. No.: US 2009/0235009 A1
(43) Pub. Date: Sep. 17, 2009

(54) Video surveillance motherboard for host computer

(76) Inventor: Chia-Wang Chiu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,495

(22) Filed: Nov. 20, 2008

(30) Foreign Application Priority Data
Mar. 12, 2008 (TW) 097204219

(51) Int. Cl. G06F 13/20

(52) U.S. Cl. 710/313

(57) ABSTRACT

A video surveillance motherboard includes a core circuit and a surveillance circuit. The core circuit includes a processor, a main memory, a bus and a chipset. The chipset couples the processor to the main memory and includes a bus controller for controlling data transfer on the bus. The surveillance circuit includes a video connector, an audio connector, plural video capture controllers and a bridge. The video and audio connectors are configured to connect with a camera via image and audio transmission lines to receive image and audio signals from the camera. The video capture controllers are coupled to image signal input terminals of the video connector and audio signal input terminals of the audio connector. The bridge couples the video capture controllers to the bus and is configured to enable the video capture controllers to transfer data through the bus.

### BACKGROUND OF INVENTION

1. Field of Invention

This invention relates to a motherboard and more particularly to a video surveillance motherboard for host computer, which is integrated with a video capture controller to provide surveillance functionality.

2. Related Prior Art

FIG. 5 illustrates a schematic block diagram of a conventional motherboard 70, such as an ATX standard motherboard, for a host computer. The motherboard 70 includes a core circuit 71 and an expansion circuit 72. The core circuit 71 includes a CPU 73, a main memory 74, a chipset 75, a bus 780 and other necessary components to perform basic operations on the host computer. The chipset 75 includes a north bridge 76 and a south bridge 77. The south bridge 77 is integrated with a bus controller 78 to control data transfer on the bus 780. On the other hand, the expansion circuit 72 includes a plurality of expansion slots 79 coupled to the bus 780. The expansion slots 79 may be inserted with a video capture card to perform surveillance functionality on the host computer.

Since there is no surveillance component embedded in the motherboard 70 of the host computer, it is necessary to buy a video capture card designed to be plugged into the expansion slots in the motherboard in order to connect with other cameras for surveillance. It wastes time and extra money to buy extra video capture card and assembly it onto the motherboard. Moreover, the number of the expansion slots is limited and provided only for a certain number of cameras.

By the way, the conventional motherboard has been embedded with many other unnecessary components, such as irrelative expansion slots, parts and wires, and therefore provides extra functions which may not be needed or used in a video surveillance system of an apartment community. It causes resources wasted in the host computer.

### SUMMARY OF INVENTION

Broadly stated, the present invention is directed to a video surveillance motherboard for a host computer. The video surveillance motherboard includes a core circuit and a surveillance circuit. The core circuit includes a processor, a main memory, a bus and a chipset. The chipset couples the processor to the main memory and includes a bus controller for controlling data transfer on the bus. The surveillance circuit includes a video connector, an audio connector, a plurality of video capture controllers and at least one bridge. The video connector includes a plurality of image signal input terminals. Each of the image signal input terminals is configured to connect with a camera via an image transmission line in order to receive an image signal from the camera. Likewise, the audio connector includes a plurality of audio signal input terminals. Each of the audio signal input terminals is configured to connect with the camera via an audio transmission line in order to receive an audio signal from the camera or microphone. The video capture controllers are respectively coupled to the image signal input terminals of the video connector and the audio signal input terminal of the audio connector. The bridge couples the video capture controllers to the bus, and is configured to enable the video capture controllers to transfer data through the bus.

According to above, the video surveillance motherboard enables cameras to be directly joined thereto without extra video capture cards needed. Furthermore, the video surveillance motherboard may be fully utilized without unnecessary parts or functions in order to connect with much more cameras.

The present invention and the advantages thereof will become more apparent upon consideration of the following detailed description when taken in conjunction with the accompanying drawings.

### BRIEF DESCRIPTION OF DRAWINGS

The invention is illustrated by the accompanying drawings in which corresponding parts are identified by the same numerals and in which:

FIG. 1 is a block diagram of a surveillance motherboard within a host computer according to one embodiment of the invention;

FIG. 2 is a plan view of the surveillance motherboard of FIG. 1;

FIG. 3 is another diagram of the surveillance motherboard of FIG. 1;

FIG. 4 is a block diagram of a surveillance motherboard according to another embodiment of the invention; and

FIG. 5 is a block diagram of a prior art motherboard.

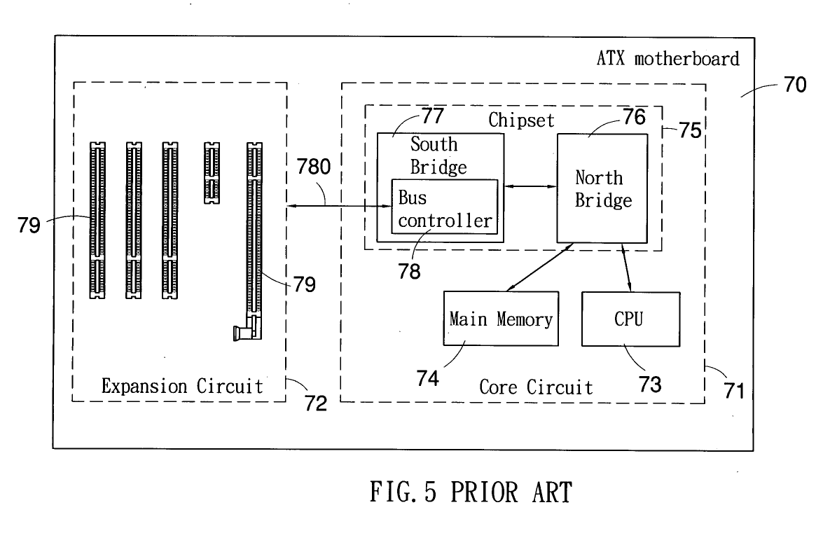

### DETAILED DESCRIPTION OF EMBODIMENTS

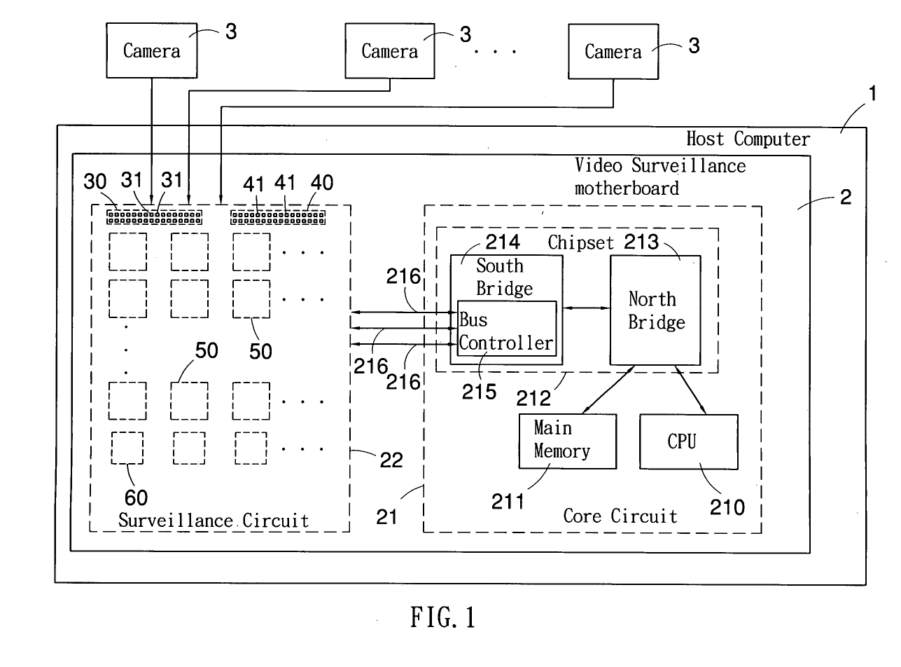

Referring now to FIGS. 1-3, a video surveillance motherboard 2 according to one embodiment of the present invention is disclosed. The surveillance motherboard 2 is incorporated within a host computer 1. A plurality of cameras 3 are positioned at various locations and each is coupled to the host computer 1. The video surveillance motherboard 2 mainly includes a core circuit 21 and a surveillance circuit 22.

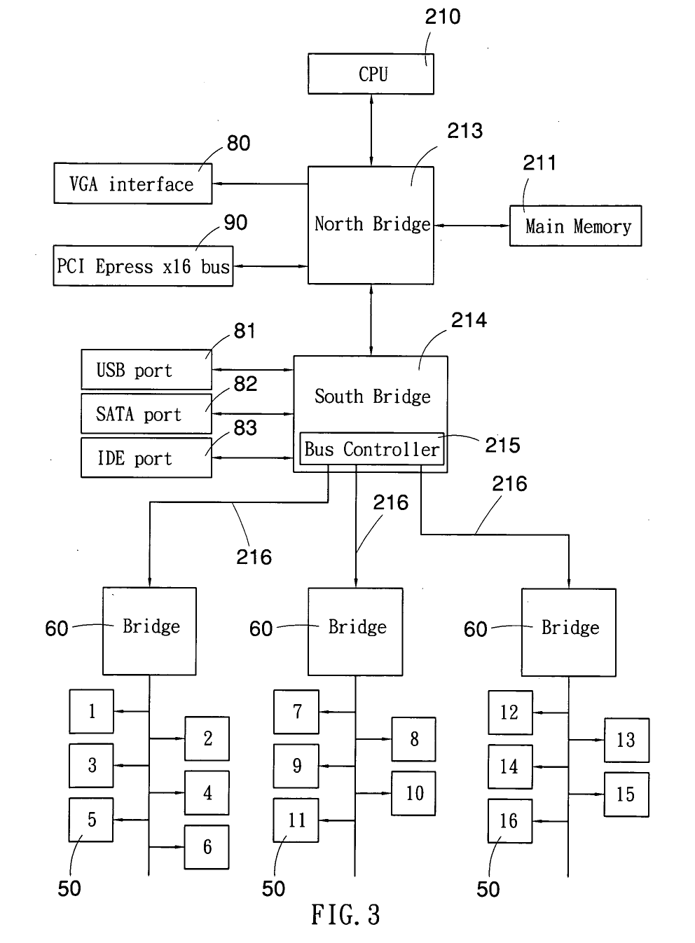

As shown in FIG. 1, the core circuit 21 is configured to perform basic operations on the host computer 1. For instance, the core circuit 21 may be the type constructed for a standard ATX, Micro ATX or other form factor motherboard. In this preferred embodiment, the core circuit 21 of the motherboard 2 includes a CPU or processor 210, a main memory 211, a chipset 212 and three buses 216. The chipset 212 includes a north bridge 213 (or a memory controller hub, MCH) and a south bridge 214 (or an I/O controller hub, ICH). The north bridge 213 couples the CPU 210 to the main memory 211. The south bridge 214 is embedded with a bus controller 215 and a SM bus controller (not shown). The bus controller 215 is provided to perform transmit/receive data transfer on the buses 216. Preferably, the bus controller 215 together with the buses 216 is constructed in compliance with the PCI standard or PCI Express standard. As best shown in FIG. 3, the north bridge 213 may be coupled to a monitor (not shown) via a VGA interface. The south bridge 214 may be coupled to storage devices or peripheral devices (not shown) via an IDE port 81, a SATA port 82 and a USB port 83. These interfaces and ports are well-known to those of ordinary skill in the art and will not be discussed further herein.

Referring back to FIG. 1, the surveillance circuit 22 of the motherboard 2 is coupled to the core circuit 21 via the buses 216 and includes a video connector 30, an audio connector 40, a plurality of video capture controllers 50 and a plurality of bridges 60. As best seen in FIG. 3, the surveillance circuit 22 of this embodiment includes sixteen video capture controllers 50 and three bridges 60 coupled to the three buses 216. In particular, one of the bridges 60 is coupled with six video capture controllers 50 while the other two each coupled with five video capture controllers 50.

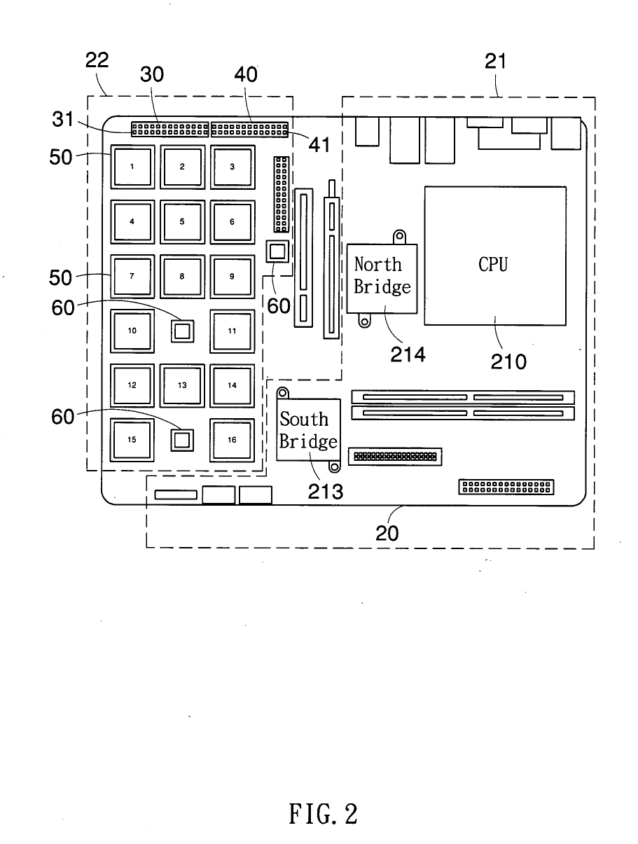

Referring back to FIG. 1 or 2, the video connector 30 has a plurality of image signal input terminals 31 formed of pin or socket type electrical terminals. In this embodiment, two socket electrical terminals constitute a set of the image signal input terminal 31. Another two constitute another set of the image signal input terminal 31 and so on. Each set of the image signal input terminals 31 is configured to connect with the respective camera 3 via an image transmission line in order to receive an image signal from the respective camera 3. Likewise, the audio connector 40 has a plurality of audio signal input terminals 41 formed of pin or socket type electrical terminals. Two socket electrical terminals constitute a set of the audio signal input terminal 41. Each set of the audio signal input terminals 41 is configured to connect with the respective camera 3 via an audio transmission line in order to receive an audio signal from the respective camera 3. Each of the video capture controllers 50 is coupled to the respective image signal input terminal 31 of the video connector 30 and the respective audio signal input terminal 41 of the audio connector 40. The bridges 60 are configured to control operations of the video capture controllers 50 and enable the video capture controllers 50 to transfer data through the buses 216. By this way, each of the video capture controllers 50 can receive the image signal from the respective image signal input terminal 31 of the video connector 30 and the audio signal from the respective audio signal input terminal of the audio connector via the respective bridge 60 and bus 216, process the image and audio signals, and transfer data via the respective bridge 60.

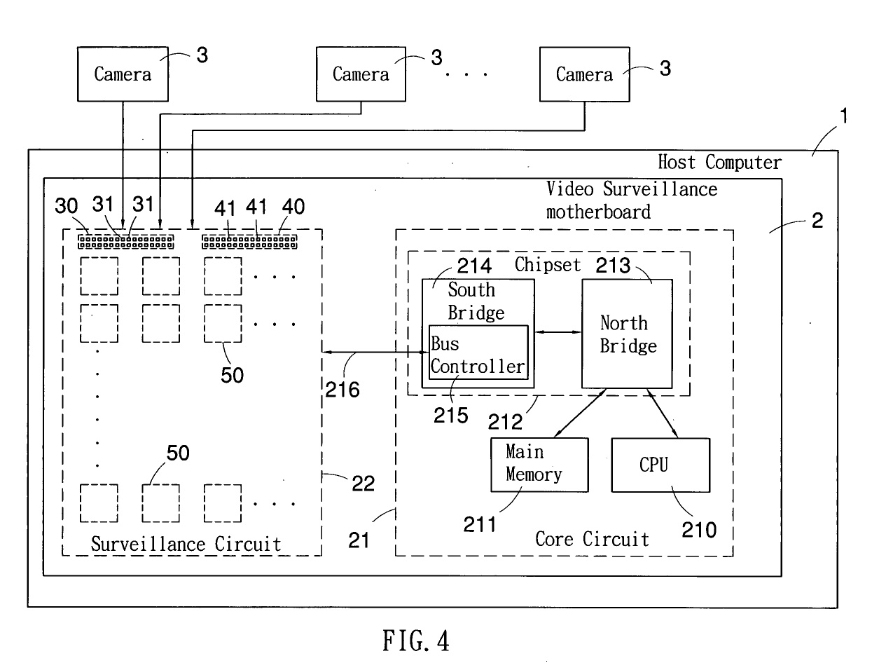

Another exemplary embodiment of the invention eliminates the bridges 60 of FIGS. 1-3 and directly couples the video capture controllers 50 to the core circuit 20 through a bus 216. As shown in FIG. 4, the video surveillance motherboard 2 within a host computer 1 includes a core circuit 21 and a surveillance circuit 22. The core circuit 21 includes a CPU or processor 210, a main memory 211, the bus 216 and a chipset 212. The chipset 212 is coupled the processor 210 to the main memory 211 and includes a north bridge 213, a south bridge 214 having a bus controller 215. The bus controller 215 controls data transfer on the bus 216.

Referring still to FIG. 4, the surveillance circuit 22 in this embodiment of the invention is coupled to the core circuit 20 via the bus 216 and includes a video connector 30, an audio connector 40 and a plurality of video capture controllers 50. The video connector 30 has a plurality of image signal input terminals 31 for connection with the respective camera 3 via an image transmission line in order to receive an image signal from the camera 3. Likewise, the audio connector 40 has a plurality of audio signal input terminals 41 for connection with the respective camera 3 via an audio transmission line in order to receive an audio signal from the camera 3. Each of the video capture controllers 50 is coupled to the respective image signal input terminal 31 of the video connector 30, the respective audio signal input terminal 41 of the audio connector 40 and the bus 216. Additionally, each of the video capture controllers 50 is configured to receive the image signal from the respective image signal input terminal 31, receive the audio signal from the respective audio signal input terminal 41, process the image and audio signals, and transfer data via the bus 216.

From the forgoing description, the present invention is directed to the video surveillance motherboard which is tightened and focus on the surveillance functionality without a needless or irrelative components or functions. The surveillance motherboard is therefore fully utilized. Additionally, a plurality of video cameras may be directly connected to the video surveillance motherboard without needs of a video capture card. The cost is therefore reduced.

It will be appreciated that although a particular embodiment of the invention has been shown and described, modifications may be made. It is intended in the claims to cover such modifications which come within the spirit and scope of the invention.

The invention claimed is:

1. A motherboard for a host computer, comprising:
a core circuit including a processor, a main memory, a bus and a chipset; said chipset coupling said processor to said main memory and including a bus controller controlling data transfer on said bus; and
a surveillance circuit coupled to said core circuit via said bus and including:
a video connector having an image signal input terminal for connection with a camera via an image transmission line in order to receive an image signal from said camera;
an audio connector having an audio signal input terminal for connection with said camera via an audio transmission line in order to receive an audio signal from said camera; and
a video capture controller coupled to said image signal input terminal of said video connector, said audio signal input terminal of said audio connector and said bus, and configured to receive said image signal from said image signal input terminal of said video connector, to receive said audio signal from said audio signal input terminal of said audio connector, to process said image signal and said audio signal, and to transfer data via said bus.

2. The motherboard of claim 1 wherein said bus controller and said bus both are in compliance with the PCI Standard.

3. The motherboard of claim 1 wherein said bus controller and said bus both are in compliance with the PCI Express Standard.

4. A motherboard for a host computer, comprising:
a core circuit including a processor, a main memory, a bus and a chipset; said chipset coupling said processor to said main memory and including a bus controller controlling data transfer on said bus; and
a surveillance circuit coupled to said core circuit via said bus and including:
a video connector having a plurality of image signal input terminals each configured to connect with a camera via an image transmission line in order to receive an image signal from said camera;
an audio connector having a plurality of audio signal input terminals each configured to connect with said camera via an audio transmission line in order to receive an audio signal from said camera;
a plurality of video capture controllers respectively coupled to said image signal input terminals of said video connector and said audio signal input terminals of said audio connector; and
a bridge coupled said video capture controllers to said bus, and configured to control operation of said video capture controllers and enable said video capture controllers to transfer data through said bus.

5. The motherboard of claim 4 wherein said bus controllers and said bus are in compliance with the PCI Standard.

6. The motherboard of claim 4 wherein said bus controllers and said bus are in compliance with the PCI Express Standard.
